(19) United States
(12) Patent Application Publication
(10) Pub. No.: US 2021/0213548 A1
(43) Pub. Date: Jul. 15, 2021

(54) RECIPROCATING SAW

(71) Applicant: MILWAUKEE ELECTRIC TOOL CORPORATION, Brookfield, WI (US)

(72) Inventors: Carmen J. Castanos, Milwaukee, WI (US); Beth E. Cholst, Wauwatosa, WI (US); Dane Laitinen, Wauwatosa, WI (US)

(21) Appl. No.: 17/149,117

(22) Filed: Jan. 14, 2021

Related U.S. Application Data
(60) Provisional application No. 62/960,891, filed on Jan. 14, 2020.

(51) Int. Cl. B23D 51/10; B23D 51/16; B23D 49/16

(52) U.S. Cl. CPC B23D 51/10; B23D 49/162; B23D 51/16

(57) ABSTRACT

A blade clamp is configured for use with a power tool having a reciprocating spindle. The blade clamp includes a cover assembly rotatably coupled to the spindle, and a detent received within a first bore of the spindle. The detent is movable in a radial direction relative to a longitudinal axis of the spindle by engagement with the cover assembly to adjust the blade clamp between a locked configuration and an unlocked configuration. The blade clamp further includes a sleeve in which the detent is slidably received. The sleeve is at least partially positioned within the first bore. A plunger is positioned within a second bore of the spindle. The second bore extends along a longitudinal axis that is parallel with the longitudinal axis of the spindle. The second bore is contiguous with a blade slot of the spindle.

### CROSS-REFERENCE TO RELATED APPLICATIONS

This application claims priority to U.S. Provisional Patent Application No. 62/960,891 filed on Jan. 14, 2020, the entire content of which is incorporated herein by reference.

### FIELD OF THE INVENTION

The present invention relates to power tools, and more particularly to a reciprocating saws.

### BACKGROUND OF THE INVENTION

Cutting tools, such as reciprocating saws, typically include a clamp for securing a cutting blade thereto. Such blade clamps may be adjustable between a locked configuration, where the blade is secured to a spindle, and an unlocked configuration, where the blade is removable from the spindle.

### SUMMARY OF THE INVENTION

The invention provides, in one aspect, a blade clamp for use with a power tool having a reciprocating spindle. The blade clamp includes a cover assembly rotatably coupled to the spindle, and a detent received within a first bore of the spindle. The detent is movable in a radial direction relative to a longitudinal axis of the spindle by engagement with the cover assembly to adjust the blade clamp between a locked configuration and an unlocked configuration. The blade clamp further includes a sleeve in which the detent is slidably received. The sleeve is at least partially positioned within the first bore. A plunger is positioned within a second bore of the spindle. The second bore extends along a longitudinal axis that is parallel with the longitudinal axis of the spindle. The second bore is contiguous with a blade slot of the spindle.

In some embodiments, a combination of the second bore and the blade slot divides the spindle into a first portion and a second portion, and the first bore extends through the first portion. In further embodiments, the blade clamp includes a pin coupled to the second portion of the spindle, and the pin includes an end positioned within the second bore but outside the blade slot. In yet further embodiments, a spring is configured to bias the plunger toward the pin, and the plunger is engageable with the pin to prevent removal of the plunger from the second bore.

The invention provides, in another aspect, a reciprocating saw including a housing, and a motor and a drive mechanism operably coupled to the motor. The motor and the drive mechanism are positioned within the housing. The drive mechanism includes a driven gear, a connecting rod, and a spindle. One end of the connecting rod is movably coupled to the spindle by a roller pin. The spindle defines a longitudinal axis. Rotary motion of the motor is translated into linear reciprocating motion of the spindle by the driven gear and the connecting rod. The reciprocating saw further includes a support assembly configured to rotationally support the roller pin within the housing. The support assembly includes a housing defining a slot extending along a longitudinal axis that is aligned with the longitudinal axis of the spindle. A first bearing is positioned within the slot and at a first end of the roller pin. A second bearing is positioned within the slot and at a second, opposite end of the roller pin. The roller pin extends transverse to the longitudinal axis of the slot. At least one of the first end and the second end of the roller pin extends completely through the first bearing and the second bearing, respectively.

The invention provides, in yet another aspect, a reciprocating saw including a housing having a battery support portion configured to receive a battery pack. The reciprocating saw further includes a motor and a drive mechanism operably coupled to the motor. The motor and the drive mechanism are positioned within the housing. The motor is configured to receive power from the battery pack. The battery support portion includes a plurality of rail members. Each rail member is engageable with a corresponding groove in the battery pack. Each rail member includes a metal support member.

Other features and aspects of the invention will become apparent by consideration of the following detailed description and accompanying drawings.

### BRIEF DESCRIPTION OF THE DRAWINGS

FIG. 1 is a side view of a reciprocating saw in accordance with an embodiment of the invention.

FIG. 2 is another side view of the reciprocating saw of FIG. 1, with a portion of a housing thereof removed, illustrating a drive mechanism of the reciprocating saw.

FIG. 3 is a cross-sectional view of the reciprocating saw of FIG. 1 taken along line 3-3 in FIG. 1, illustrating a blade clamp and an output shaft of the reciprocating saw.

FIG. 4 is a top view of the reciprocating saw of FIG. 1, with portions thereof removed, illustrating the drive mechanism of the reciprocating saw of FIG. 2.

FIG. 5 is a perspective view of the blade clamp and output shaft of FIG. 3.

FIG. 6 is a perspective view of a portion of the blade clamp and output shaft of FIG. 5.

FIG. 7 is a cross-sectional view of the blade clamp and the output shaft of FIG. 5 taken along line 7-7 in FIG. 5, illustrating a detent of the blade clamp in a slot of the output shaft.

FIG. 8 is another cross-sectional view of the blade clamp and the output shaft of FIG. 5 taken along line 8-8 in FIG. 7.

FIG. 9 is a side view of the drive mechanism of FIG. 2.

FIG. 10 is a cross-sectional view of the drive mechanism of FIG. 9 taken along line 10-10 in FIG. 9, illustrating a pivot pin of the drive mechanism.

FIG. 11 is a rear perspective view of a battery support portion of a housing of the reciprocating saw of FIG. 1.

FIG. 12 is a front perspective view of the battery support portion of FIG. 1

FIG. 13 is a cross-sectional view of the battery support portion of FIG. 11 taken along line 13-13 in FIG. 12.

FIG. 14 is a cross-sectional view of the battery support portion of FIG. 11 taken along line 12-12 in FIG. 11, illustrating a support member.

FIG. 15 is a perspective view of the support member of FIG. 14.

FIG. 16 is a perspective view of the battery pack of the reciprocating saw of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

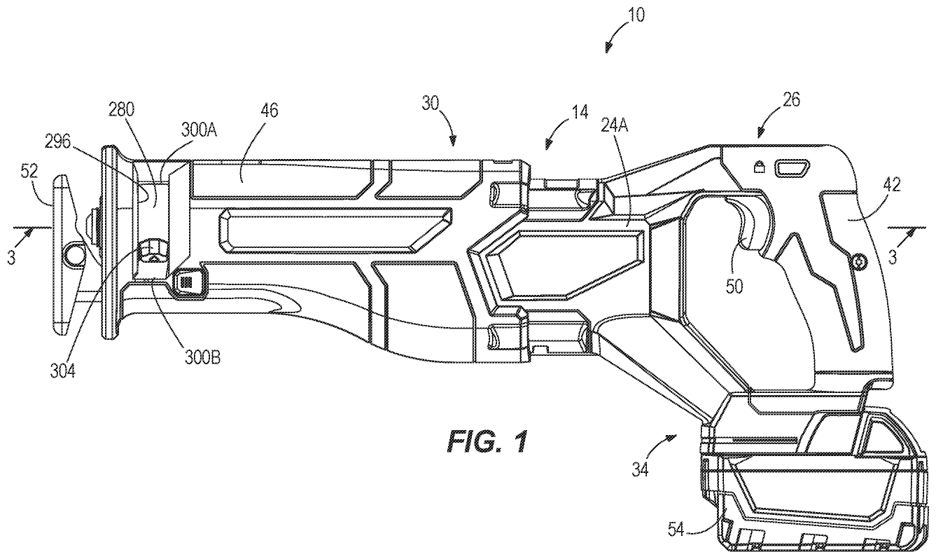

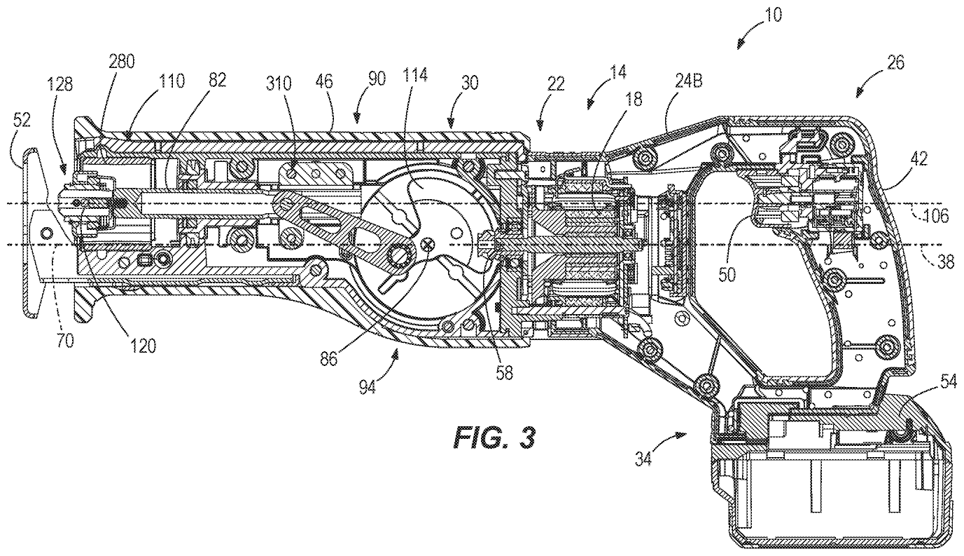

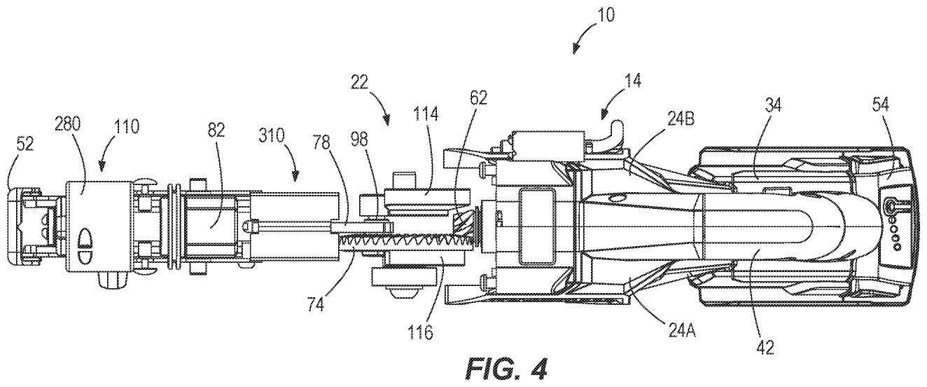

FIGS. 1-4 illustrate a reciprocating saw 10 including a housing 14, a motor 18 (FIG. 3) positioned within the housing 14, and a drive mechanism 22 coupled to the motor 18 and positioned within the housing 14. As illustrated in FIG. 4, the housing 14 is comprised of two clamshell halves 24A, 24B that are connected together along a plane. In the illustrated embodiment, the clamshell halves 24A, 24B are secured together with threaded fasteners (e.g., screws), but may alternatively be secured together using other suitable coupling means.

Referring back to FIG. 1, the housing 14 includes a rearward portion 26, a forward portion 30, and a battery support portion 34. The housing 14 also defines a longitudinal axis 38 (FIG. 3) that extends through the rearward and forward portions 26, 30. The forward portion 30 is configured to support the drive mechanism 22. In addition, the rearward portion 26 includes a D-shaped handle 42, and the forward portion 30 includes a grip 46. The D-shaped handle 42 and the grip 46 are configured to be grasped by a user during operation of the reciprocating saw 10. An actuator or trigger 50 is supported by the rearward portion 26 adjacent the D-shaped handle 42. The trigger 50 is actuatable by a user to selectively power the motor 18. In the illustrated embodiment, the longitudinal axis 38 generally divides the housing 14 into an upper section and a lower section. The trigger 50 is positioned above of the longitudinal axis 38 (i.e., from the frame of reference of FIG. 3). A shoe 52 (FIGS. 1-4) extends from and is pivotally coupled to the forward portion 30 of the housing 14. The shoe 52 pivots about a pivot axis and facilitates aligning the reciprocating saw 10 on a work piece to be cut.

The battery support portion 34 is formed on the rearward portion 26 of the housing 14 below the D-shaped handle 42. In the illustrated embodiment, the battery support portion 34 is located below the longitudinal axis 38 of the housing 14 (i.e., from the frame of reference of FIG. 3). In other embodiments, the battery support portion 34 may be located elsewhere on the housing 14. The battery support portion 34 is configured to receive a battery pack 54 (e.g., an 18 volt Li-ion power tool battery pack) (FIG. 1) and electrically connect the battery pack 54 to the motor 18. In other embodiments, the battery pack 54 may have different voltages and/or chemistries. In still other embodiments, the reciprocating saw 10 may include a power cord such that the motor 18 is powered by an AC power source (e.g., a wall outlet, a portable generator, etc.).

As shown in FIGS. 3 and 4, the motor 18 is positioned within the housing 14 between the rearward portion 26 and the forward portion 30. The motor 18 is also electrically connected to the battery pack 54 (or other suitable power source), and includes a motor shaft 58 (FIG. 3) and an output gear or pinion 62 (FIG. 4). The motor shaft 58 defines a central longitudinal axis 70, or motor axis, of the motor 18. In the illustrated embodiment, the central longitudinal axis 70 of the motor 18 is generally aligned or coaxial with the longitudinal axis 38 of the housing 14. When powered, the motor 18 rotates the motor shaft 58 and the pinion 62 about the axis 70 to drive the drive mechanism 22.

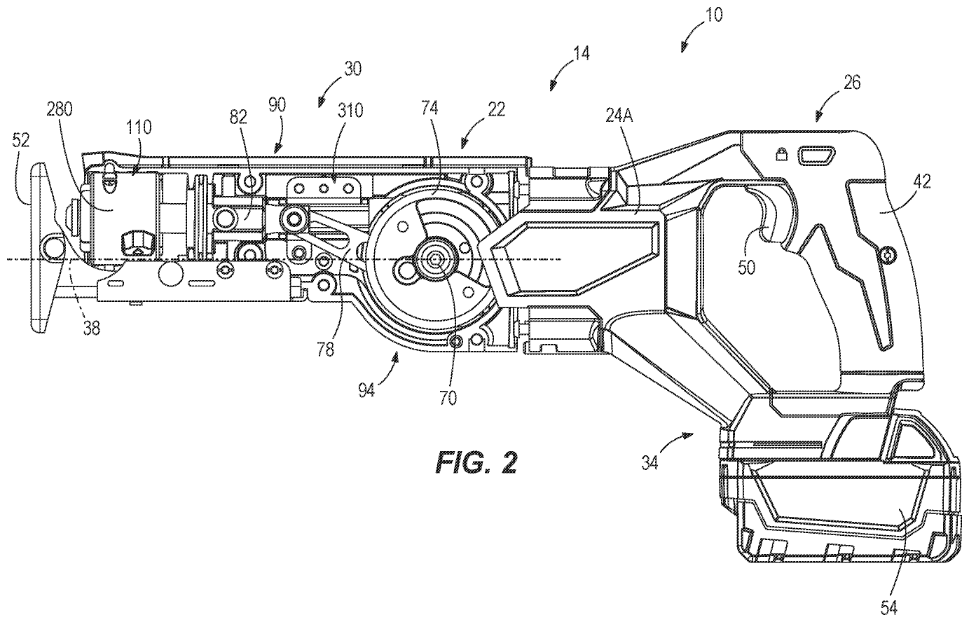

As shown in FIGS. 2-4, the drive mechanism 22 is positioned at least partially within the forward portion 30 of the housing 14 between the motor 18 and the shoe 52. The illustrated drive mechanism 22 is a slider-crank mechanism that includes a driven gear 74, a connecting rod 78, and an output shaft 82. The driven gear 74 engages the pinion 62 of the motor 18 and defines a central axis 86 about which the gear 74 rotates. In the illustrated embodiment, the central axis 86 is perpendicular to the longitudinal axis 38 of the housing 14, and extends between opposing sides of the housing 14. The driven gear 74 is thereby oriented parallel with the longitudinal axis 38 within the housing 14.

As illustrated in FIG. 3, the longitudinal axis 38 of the housing 14 and the central axis 70 of the motor 18 extend through a center of the gear 74 (i.e., through the central axis 86) to divide the gear 74 into a first, or upper, portion 90 and a second, or lower, portion 94. In the illustrated embodiment, the upper portion 90 of the driven gear 74 is located on the same side of the longitudinal axis 38 as the output shaft 82 and the trigger 50, while the lower portion 94 of the driven gear 74 is located on the same side of the longitudinal axis 38 as the battery support portion 34. In other embodiments, the output shaft 82 may be located on the opposite side of the longitudinal axis 38 such that the lower portion 94 of the driven gear 74 is located on the same side of the longitudinal axis 38 as the output shaft 38. It should be understood that what constitutes the upper and lower portions 90, 94 of the driven gear 74 changes during operation of the drive mechanism 22 because the gear 74 rotates. The terms “upper” and “lower” are simply illustrative terms used to help describe volumes of spaces above and below the axes 38, 70 that are occupied by sections of the gear 74 at any given time. At a particular instance in time, the actual section of the gear 74 that qualifies as the “upper portion” or the “lower portion” is different than at another instance in time.

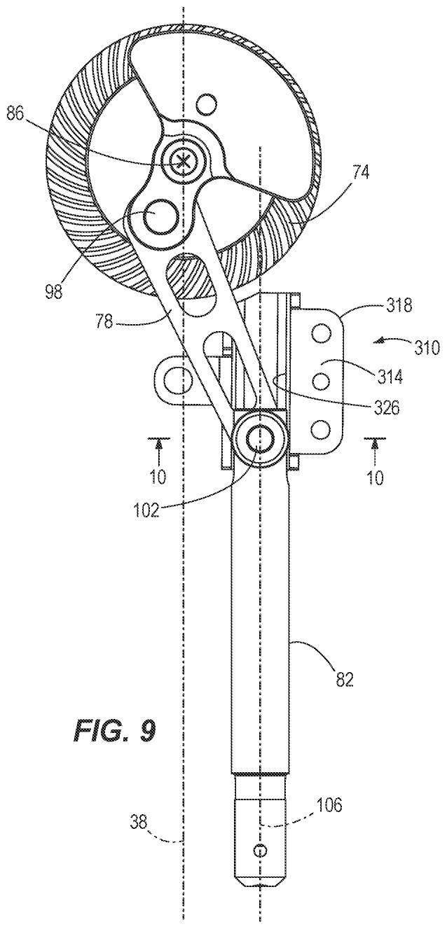

With reference to FIGS. 4 and 9, the connecting rod 78, or drive arm, includes a first end that is coupled to the driven gear 74 by a crank pin 98 and a second end that is coupled to the output shaft 82 by a roller pin 102. The crank pin 98 is offset from the central axis 86 of the driven gear 74 such that, as the gear 74 is rotated, the crank pin 98 moves about the central axis 86. As the first end of the connecting rod 78 moves with the driven gear 74, the second end of the connecting rod 78 pushes and pulls the output shaft 82 in a reciprocating motion. The crank pin 98 allows the connecting rod 78 to pivot vertically relative to the driven gear 74 (i.e., from the frame of reference of FIG. 9), while the roller pin 102 pivotably connects the connecting rod 78 to the output shaft 82.

The output shaft 82, or spindle, reciprocates within the forward portion 30 of the housing 14 generally along a spindle axis 106. In the illustrated embodiment, as illustrated in FIG. 3, the spindle axis 106 is generally parallel with and positioned above the longitudinal axis 38 of the housing 14. Rotary motion of the motor 18 is thereby translated into linear reciprocating motion of the output shaft 82 by the driven gear 74 and the connecting rod 78.

With reference to FIGS. 2-4, the illustrated drive mechanism 22 also includes a first counterweight 114 and a second counterweight 116. The first and second counterweights 114, 116 help balance forces generated by the output shaft 82 and an attached saw blade during reciprocating movement. In the illustrated embodiment, the first counterweight 114 and the second counterweight 116 are separate elements, but may alternatively be integrally formed as a single piece. More specifically, the second counterweight 116 and the driven gear 74 are integrally formed as a single piece, and the first and second counterweights 114, 116 are spaced apart from each other along the axis 86. In alternative embodiments, the second counterweight 116 and the driven gear 74 may be separate components.

With continued reference to FIG. 3, a blade clamp 110 is coupled to an end of the output shaft 82 opposite from the connecting rod 78. The blade clamp 110 receives and secures the saw blade, or other tool element, within a blade slot 120 in the output shaft 82 for reciprocating movement with the output shaft 82. The output shaft 82 supports the saw blade such that, during operation of the reciprocating saw 10, the drive mechanism 22 moves the saw blade through a cutting stroke when the output shaft 82 is pulled by the connecting rod 78 from an extended position to a retracted position, and through a return stoke when the output shaft 82 is pushed by the connecting rod 78 from the retracted position to the extended position.

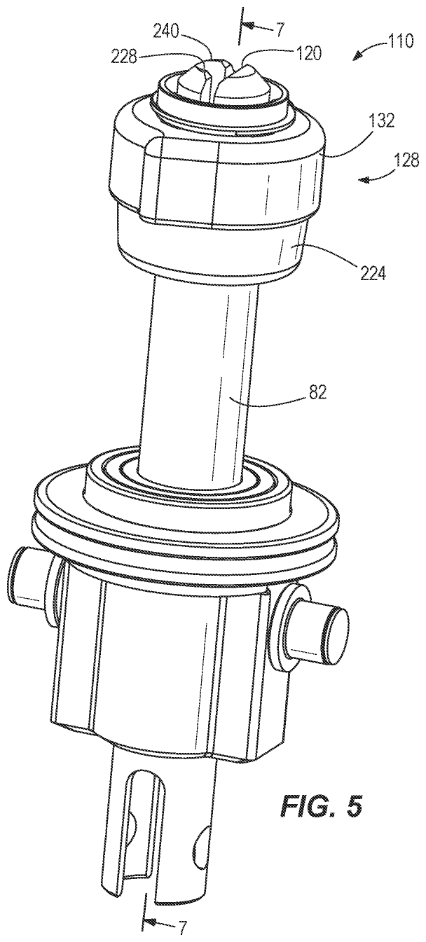

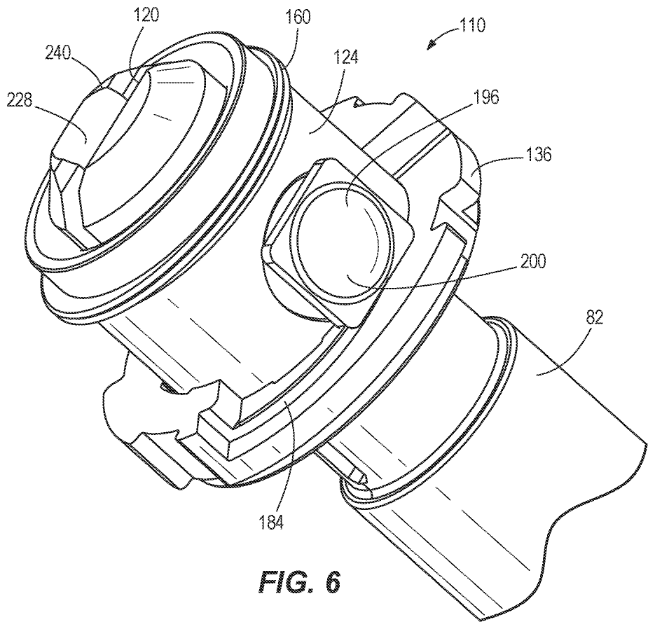

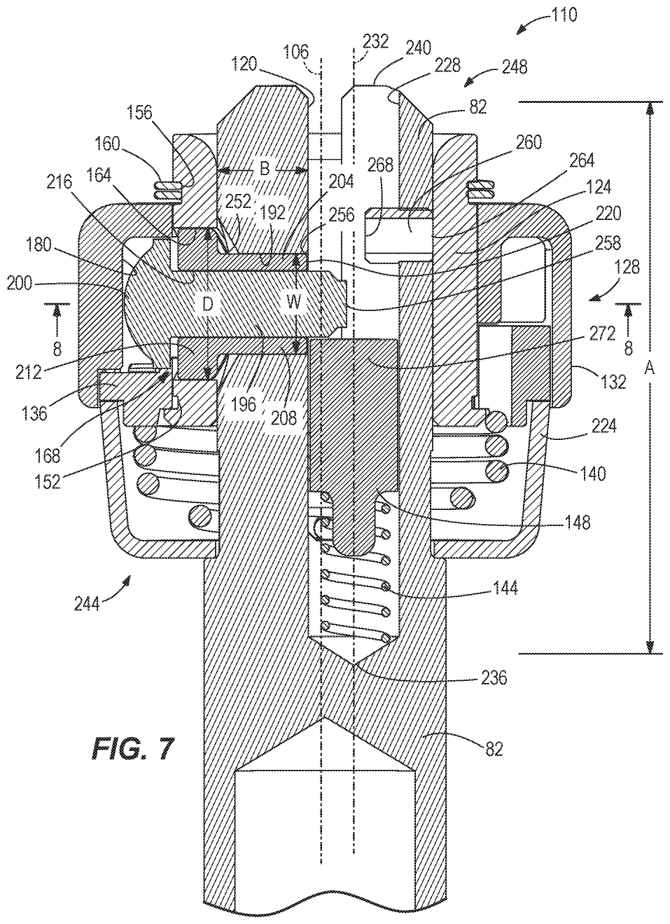

With reference to FIGS. 5-8, the blade clamp 110 includes a body 124 (FIG. 6) axially and rotationally fixed to the output shaft 82 and a cover assembly 128 (FIG. 5) rotatably coupled to the body 124. The cover assembly 128 includes a first, outer cover member 132 and a second, inner cover member 136 coupled together for co-rotation about the spindle axis 106. The blade clamp 110 includes a torsion spring 140 (FIG. 7) coupling the output shaft 82 and the cover assembly 128, and a compression spring 144 and a plunger 148 positioned within the blade slot 120 of the output shaft 82.

With reference to FIG. 7, the inner cover member 136 is partially received in a first circumferential groove 152 of the body 124. The body 124 further includes a second circumferential groove 156 spaced from the first circumferential groove 152. The second circumferential groove 156 is configured to receive a retaining clip 160 for axially securing the cover assembly 128 to the body 124 while allowing rotation of the cover assembly 128. The body 124 includes a pocket or opening 164 extending radially through the body 124. The illustrated opening 164 is positioned between the first and second circumferential grooves 152, 156.

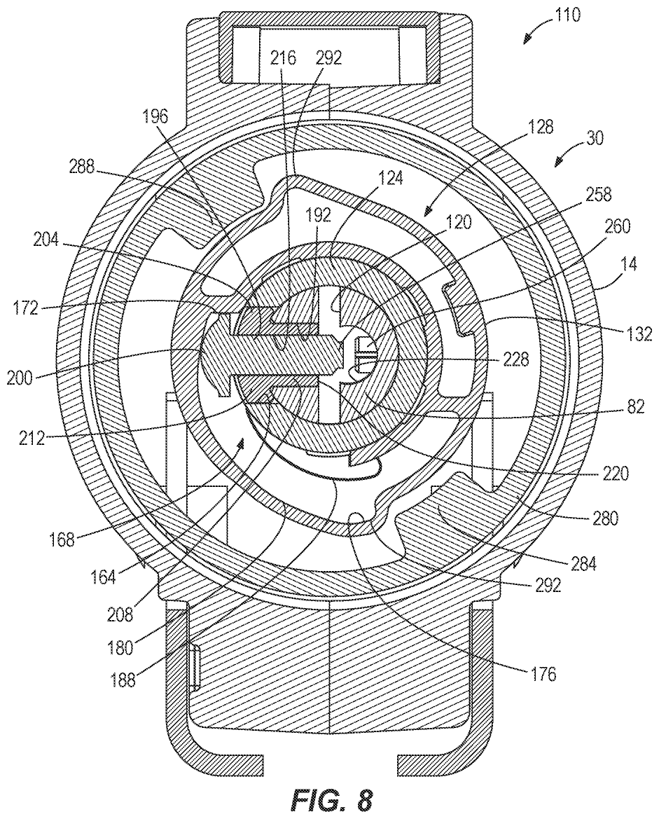

With reference to FIG. 8, the outer cover member 132 includes an internal cavity 168 defined by a first, shallow end 172 and a second, deep end 176 circumferentially spaced from the shallow end 172. The internal cavity 168 is also defined between a ramped surface 180 of the outer cover member 132, and a ramped surface 184 (FIG. 6) of the inner cover member 138. In particular, the ramped surfaces 180, 184 have a progressively increasing radius from the spindle axis 106, extending between the shallow end 172 and the deep end 176. Further, in the illustrated embodiment, the outer cover member 132 includes another ramped surface 188 (FIG. 8) spaced radially inward of the ramped surface 180. Rotation of the cover assembly 128 rotates the ramped surfaces 180, 184, 188 relative to the output shaft 82, as further discussed below.

With continued reference to FIG. 8, the output shaft 82 includes a first, radial bore 192. Both the opening 164 and the first bore 192 are configured to receive a lock pin or detent 196 such that the detent 196 extends radially through the body 124 and at least partially through the output shaft 82. The detent 196 is configured to move radially relative to the spindle axis 106 within the opening 164 and the first bore 192. Specifically, the ramped surface 180 of the first cover member 132 is configured to engage a head 200 of the detent 196 to impart radial displacement thereto toward the spindle axis 106. Furthermore, the detent 196 is further configured to displace radially through an aperture in the blade when the blade is inserted axially into the blade slot 120 to axially secure the blade to the output shaft 82.

With reference to FIGS. 7-8, the blade clamp 110 includes a sleeve 204 received within the opening 164 and the first bore 192. The sleeve 204 includes a cylindrical portion 208, a flange portion 212, and an aperture 216 extending through the cylindrical and flange portions 208, 212. The detent 196 is received within the aperture 216 such that the cylindrical portion 208 surrounds the detent 196 within the first bore 192, and the flange portion 212 of the sleeve 204 is positioned within the opening 164 of the body 124. The flange portion 212 has a generally rounded shape such that the flange portion 212 may be received within the opening 164 without interfering with the first and second cover members 132, 136. In addition, a top surface of the flange portion 212 may be adjacent and in contact with the underside of the head 200 of the detent 196 such that the sleeve 204 does not extend into the blade slot 120 in any configuration or state of the blade clamp 110. This may inhibit or prevent the blade from engaging with the sleeve 204.

The sleeve 204 is formed of a non-corrosive material. For example, the illustrated sleeve 204 is formed of stainless steel. Because a substantial portion of the detent 196 is surrounded by the sleeve 204, the amount of exposed surface area of the detent 196 is reduced, thereby inhibiting corrosion of the blade clamp 110, and the detent 196 in particular. Particularly, in one manner of operation of the saw 10 incorporating the blade assembly 110, the sleeve 204 reduces or eliminates contact between the detent 196 and liquid from pipes being cut using the saw 10.

With reference to FIGS. 7-8, the flange portion 212 of the sleeve 204 has an outer diameter D that is greater than a width W of the first bore 192 such that the flange portion 212 is configured to limit radial inward movement of the sleeve 204. As such, an end 220 of the sleeve 204 opposite the flange portion 212 cannot protrude into the blade slot 120. Therefore, the sleeve 204 cannot engage the blade when the blade is axially inserted into the blade slot 120, and also the plunger 148 such that the sleeve 204 is not load bearing.

With reference to FIG. 7, the torsion spring 140 includes a first end secured to the output shaft 82. A second, opposite end is attached to the second cover member 136. The blade clamp 110 further includes a spring cover 224 secured to the output shaft 82. The spring cover 224 may limit or prevent detachment (i.e., in an axial and/or radial direction) of the second end of the torsion spring 140 from the output shaft 82 and the second cover member 136. And, the spring cover 224 encloses the torsion spring 140 to inhibit liquid or other debris from contacting the torsion spring 140, thereby inhibiting corrosion of the torsion spring 140. The torsion spring 140 biases the cover assembly 128 toward a first rotational position relative to the body 124 and output shaft 82 coinciding with a locked configuration of the blade clamp 110. The cover assembly 128 is rotatable against the bias of the torsion spring 140 toward a second rotational position relative to the body 124/output shaft 82 coinciding with an unlocked configuration of the blade clamp 110. In the illustrated embodiment, the torsion spring 140 biases the cover assembly 128 in a counter-clockwise direction (from the frame of reference of FIG. 8).

The head 200 of the detent 196 is positioned between the outer and inner cover members 132, 136. More specifically, the head 200 is positioned between the inner ramped surface 188 of the outer cover member 132 and the outer ramped surfaces 180, 184 of the outer and inner cover members 132, 136, respectively, when the blade clamp 110 is in the unlocked positioned. The ramped surface 180 is configured to engage a top side of the head 200 to impart radially inward displacement to the detent 196 when the blade clamp 110 is adjusted from the unlocked position toward the locked position. The ramped surfaces 184, 188 are configured to engage a bottom side of the head 200 to impart radially outward displacement to the detent 196 when the blade clamp is adjusted from the locked configuration to the unlocked configuration. As such, the ramped surfaces 180, 184, 188 may facilitate radial movement of the detent 196 when the blade clamp 110 is adjusted between both the locked and unlocked configurations. In other embodiments, the outer cover member 132 does not include the ramped surface 188 such that only the ramped surface 184 of the inner cover member 136 facilitates the radial outward movement of the detent 196 when the blade clamp 110 is adjusted from the locked configuration to the unlocked configuration.

With reference to FIGS. 7 and 8, the output shaft 82 includes a second bore 228 that is contiguous with the blade slot 120. The second bore 228 extends along a bore longitudinal axis 232 from a first end 236 to a second end 240. The second end 240 of the bore 228 is exposed to the end of the output shaft 82 (FIG. 7). The bore longitudinal axis 232 is parallel with the spindle axis 106. The second bore 228 has a length A extending between the first end 236 and the second end 240. The blade slot 120 extends from the second end 240 toward the first end 236. More specifically, the blade slot 120 has a length (along the spindle axis 106) that is less than the length A of the second bore 228.

Further, the second bore 228 is positioned offset relative to the spindle axis 106 within the output shaft 82. In other words, the bore longitudinal axis 232 is not co-linear with the spindle axis 106. In the illustrated embodiment, the bore longitudinal axis 232 is radially or laterally spaced (i.e., to the right from the frame of reference of FIG. 7) relative to the spindle axis 106. Accordingly, the second bore 228 is positioned asymmetrically within the output shaft 82.

A combination of the second bore 228 and the blade slot 120 splits or divides the output shaft 82 into a first side portion 244 and a second side portion 248, with the bore longitudinal axis 232 passing between the first and second side portions 244, 248. The first side portion 244 includes the first bore 192 such that the first bore 192 extends radially from a first end 252 to a second end 256 through the first side portion 244. The first bore 192 has a predetermined length B extending between the first end 252 and the second end 256. The asymmetry of the second bore 228 relative to the spindle axis 106 causes the first side portion 244 of the output shaft 82 (i.e., the side to the left of the spindle axis 106 from the frame of FIG. 7) to have more material than the second side portion 248 for increasing the predetermined length B. The predetermined length B may inhibit or prevent tilting of the sleeve 204 within the first bore 192.

With continued reference to FIG. 7, the compression spring 144 includes opposite first and second ends. The first end is seated against the first end 236 of the second bore 228. The second end is seated against the plunger 148, which is positioned within the second bore 228. The compression spring 144 biases the plunger 148 along the bore longitudinal axis 232 toward a distal end 258 of the detent 196 (i.e., to the top from the frame of reference of FIG. 7). As such, the plunger 148 is axially displaceable within the blade slot 120 in opposite directions along the bore longitudinal axis 232.

The blade clamp 110 further includes a pin 260 secured to the output shaft 82. In the illustrated embodiment, the pin 260 includes a first end 264 affixed to the output shaft 82 and a second, opposite end 268 extending into the second bore 228. A tip of the plunger 148 is configured to engage the pin 260 when the blade clamp 110 is in the unlocked configuration. As such, the pin 260 limits the axial movement of the plunger 148 along the bore longitudinal axis 232. Furthermore, the blade is configured to contact the tip of the plunger 148 for moving the plunger 148 along the bore longitudinal axis 232, away from the pin 260 (and the detent 196) (i.e., to the bottom from the frame of reference of FIG. 7). More specifically, the plunger 148 is axially moved against the bias of the compression spring 144 away from the detent 196 within the blade slot 120 by the blade when the blade is axially inserted into the blade slot 120. The second end 268 of the pin 260 does not protrude into the blade slot 120, and as a result the second end 268 of the pin 260 does not interfere with the blade when the blade is inserted into the blade slot 120.

When the blade clamp 110 is in the unlocked configuration, the front end of the plunger 148 is engaged with the pin 260 and the distal end 258 of the detent 196 is engageable with an outer circumferential surface 272 of the plunger 148, such that the plunger 148 limits radially inward movement of the detent 196.

With reference to FIGS. 2 and 8, the saw 10 includes a barrel 280 that surrounds at least a portion of the blade clamp 110. The barrel 280 further includes a plurality of projections 284, 288 extending from an inner surface of the barrel 280. In particular, the projections 284, 288 extend toward the first cover member 132 of the cover assembly 128. The projections 284, 288 may selectively engage the first cover member 132 for facilitating adjustment of the blade clamp 110 from the locked position toward the unlocked position. Specifically, the projections 284, 288 engage tabs or arm members 292 of the outer cover member 132 when the barrel 280 is rotated (clockwise from the frame of reference of FIG. 8), thereby rotating the cover assembly 128 to release the blade. Further, the projections 284, 288 are positioned at predetermined circumferential locations on the barrel 280 such that the projections 284, 288 do not contact (i.e., rub against) the first cover member 132 during operation of the saw 10, unless the blade clamp 110 is being adjusted toward the unlocked configuration.

With reference to FIG. 1, the grip 46 includes a window 296 extending circumferentially between two ends 300A, 300B. In addition, the forward portion 30 of the housing 14 includes a corresponding window (not shown) aligned with the window 296 of the grip 46. The barrel 280 includes a projection 304 extending outwardly from an outer surface of the barrel 280. The projection 300 extends through the window of the forward portion 30, and through the window 296 of the grip 46. In particular, the ends 300A, 300B of the window 296 limit circumferential movement of the barrel 280 relative to the grip 46 and the blade clamp 110 (i.e., the first cover member 132). The projection 304 is engageable by a user for adjusting the blade clamp 110 from the locked configuration to the unlocked configuration.

The blade clamp 110 is adjustable between the locked configuration and the unlocked configuration. Specifically, insertion of the blade into the blade slot 120 and rotation of the cover assembly 128 by the torsion spring 140 rotates the ramped surface 180 of the outer cover member 132 for engagement with the detent 196, thereby imparting radially inward displacement to the detent 196. Rotation of the cover assembly 128 by a user permits the detent 196 to be moved radially outward (i.e., toward/away from the spindle axis 106).

In operation, when the blade clamp 110 is in the unlocked configuration, the plunger 148 is biased by the compression spring 144 such that the plunger 148 engages the pin 260 within the second bore 228. In particular, the cover assembly 128 is in the second rotational position such that the head 200 is positioned within the deep end 176 of the internal cavity 168, and the detent 196 is maintained radially outward (away from the bore longitudinal axis 232) by the engagement with the plunger 148. The cover assembly 128 is rotationally constrained in the second rotational position against the bias of the torsion spring 140 by the head 200 of the detent 196 positioned in the deep end 176. As such, the engagement between the plunger 148 and the detent 196 maintains the blade clamp 110 in the unlocked position.

During insertion of the blade into the blade slot 120, the blade displaces the plunger 148 rearward (i.e., to the bottom from the frame of reference of FIG. 7) along the bore longitudinal axis 232 against the bias of the compression spring 144. After the plunger 148 disengages the distal end 258 of the detent 196, the torsion spring 140 rebounds to rotate the cover assembly 128 (e.g., counter-clockwise from the frame of reference of FIG. 8) about the body 124 and output shaft 82 from the second rotational position to the first rotational position. In particular, the biasing force of the torsion spring 140 rotates the cover assembly 128 such that the ramped surfaces 180, 184, 188 move relative to the head 200 of the detent 196, thereby repositioning the head 200 from the deep end 176 of the internal cavity 168 into the shallow end 172. Simultaneously, the detent 196 is displaced radially inward through the blade slot 120, and the blade in the blade slot 120, thereby completing the transition of the blade clamp 110 to the locked configuration. As such, insertion of the blade by a user automatically adjusts the blade clamp 110 from the unlocked configuration to the locked configuration.

The blade clamp 110 is adjustable to the unlocked configuration by rotation of the cover assembly 128 by a user (i.e., via rotation of the barrel 280 by the user) in a clockwise direction (from the frame of reference of FIG. 8). The outer cover member 132 is rotated about the body 124 and output shaft 82 against the bias of the torsion spring 140 from the first rotational position to the second rotational position such that the ramped surfaces 180, 184, 188 moves relative to the head 200 of the detent 196. In particular, the movement of the cover assembly 128 causes the ramped surfaces 184, 188 to impart radially outward displacement of the detent 196, thereby adjusting the position of the head 200 from the shallow end 172 of the internal cavity 168 into the deep end 176. After the distal end 258 of the detent 196 is partially removed from the blade slot 120, the compression spring 144 rebounds, thereby axially displacing the plunger 148 along the bore longitudinal axis 232 to partially eject the saw blade from the blade slot 120, completing the transition of the blade clamp 110 to the unlocked configuration. The plunger 148 (i.e., the circumferential surface 272), by the force of the compression spring 144, remains in contact with the distal end 258 of the detent 196 for again maintaining the blade clamp 110 in the unlocked configuration until the blade is inserted into the blade slot 120. Because the blade clamp 110 is normally maintained in the unlocked configuration when a blade is not attached, the blade clamp 110 may allow insertion of the blade by the user only using one hand.

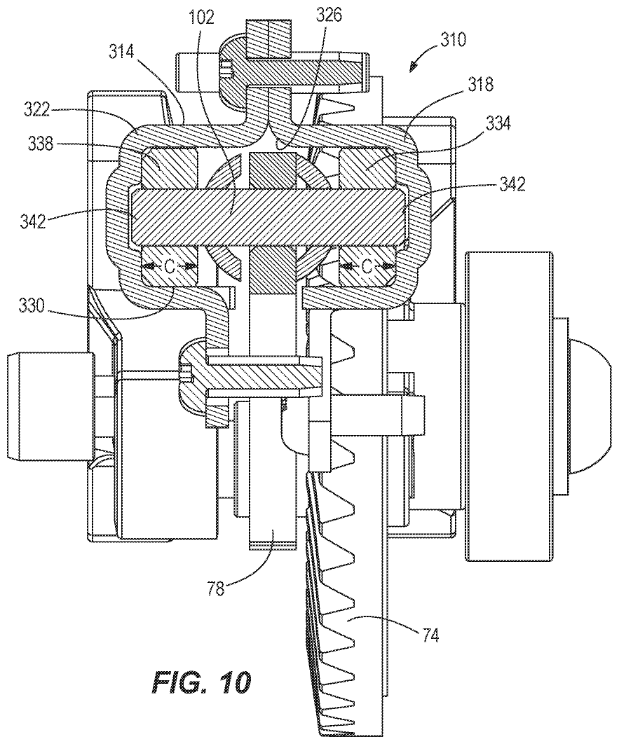

With reference to FIGS. 9 and 10, the saw 10 additionally includes a roller pin support assembly 310 (FIG. 2) configured to rotationally support the roller pin 102 within the forward portion 30 of the saw 10. The roller pin support assembly 310 includes a housing 314 surrounding the connection between the connecting rod 78 and the output shaft 82. The illustrated housing 314 is formed by a first section 318 and a second section 322 coupled together (FIG. 10). In other embodiments, the housing 314 may be formed by a single piece.

The housing 314 defines a roller pin slot 326 (e.g., orbital slot) aligned with the spindle axis 106. In the illustrated embodiment, the roller pin slot 326 is formed by curved surfaces 330 of the housing 314. The roller pin 102 is configured to move axially in a reciprocating motion along the roller pin slot 326.

As illustrated in FIG. 10, the roller pin slot 326 is configured to receive a first bearing 334 and a second bearing 338. The opposite end portions 342 of the roller pin 102 are rotatably supported, respectively, by the first bearing 334 and the second bearing 338. In addition, the roller pin 102 extends in a direction perpendicular to the spindle axis 106 such that each end portion 342 extends completely through the respective bearings 334, 338. More specifically, each end portion 342 of the roller pin 102 extends completely through a thickness C of the respective bearings 334, 338, such that at least a small part of each end portion 342 extends beyond the respective bearings 334, 338. This may inhibit or reduce asymmetrical wear on each end portion 342 of the roller pin 102, thereby increasing a service life of the roller pin 102.

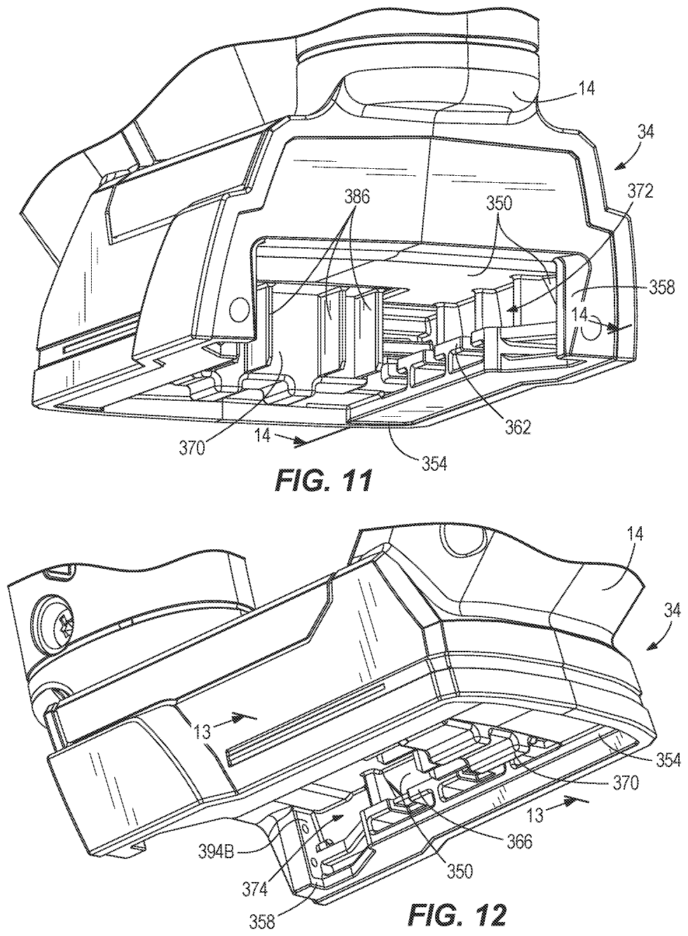

With reference to FIGS. 11-15, the battery support portion 34 includes rail members 362, 366 and a tool terminal block 370. The rail members 362, 366 extend from corresponding interior surfaces 350 of the battery support portion 34. The rails members 362, 366 are spaced apart and are substantially parallel. A plurality of grooves or channels 372, 374 are defined between the associated rail member 362, 366 and an upper interior surface of the battery support portion 34. The rail members 362, 366 are engageable with corresponding grooves 368 in the battery pack 54. In the illustrated embodiment, as illustrated in FIG. 16, the battery pack 54 includes a plurality of projections 378, 382 to form the grooves 368 (only one of which is shown). More specifically, each channel 372, 374 is configured to receive at least a portion of one of the plurality of projections 378, 382.

The tool terminal block 370 is positioned between the rail members 362, 366 and includes a set of tool terminals 386 configured to electrically connect to battery terminals 388 of the battery pack 54 (FIG. 16) when the battery pack 54 (or portions thereof) is received in the channels 372, 374.

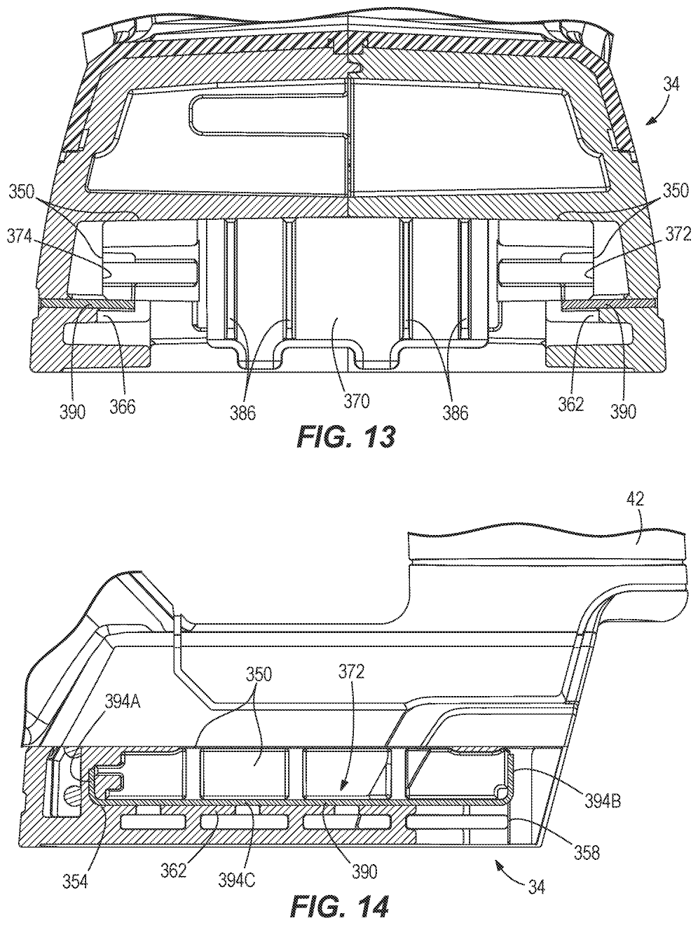

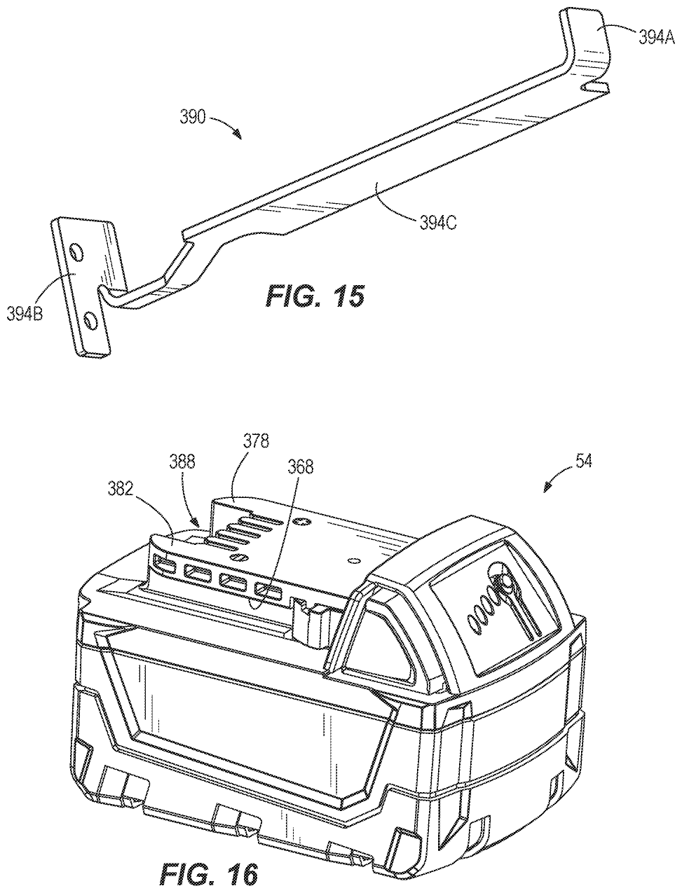

As illustrated in FIGS. 13-14, each rail member 362, 366 of the battery support portion 34 includes a support member 390 positioned on a surface of the respective rail member 362, 366 defining the channel 372, 374. In the illustrated embodiment, as shown in FIG. 15, each support member 390 includes a plurality of sections 394A-394C. The illustrated support member 390 includes a first section 394A, a second section 394B, and a third section 394C extending between the first and second sections 394A, 394B, respectively. The third section 394C is flat and is positioned along the surface of the respective rail member 362, 366 defining the channel 372, 374. Accordingly, each support member 390 is parallel with the respective rail member 362, 366. The first section 394A is positioned at and coupled to one end 354 of the battery support portion 34. The second section 394B is positioned at and coupled to an opposite, second end 358 of the battery support portion 34.

The illustrated first and second sections 394A, 394B, respectively, are positioned at an angle relative to the third section 394C. As shown in FIG. 15, the angle is about 90 degrees relative to the third section 394C for each of the first and second sections 394A, 394B, respectively. In other embodiments, the first section 394A may be positioned at an angle relative to the third section 394C that is different than the second section 394B relative to the third section 394C.

Each support member 390 is formed from a metal (e.g., steel). In addition, each support member 390 is formed by metal stamping process. The support member 390 is positioned on each rail member 362, 366 such that the projections 378, 382 of the battery pack 54 are configured to ride along the respective support members 390 when coupling the battery pack 54 to the battery support portion 34. In some embodiments, the support members 390 are attached to the respective rail members 362, 366 after the housing 14 is manufactured. In other embodiments, the support members 390 may be insert-molded with the respective clamshell halves 24A, 24B. Using the support members 390 may inhibit or reduce wear on the rail members 362, 366 during insertion and removal of the battery pack 54.

Although the invention has been described in detail with reference to certain preferred embodiments, variations and modifications exist within the scope and spirit of one or more independent aspects of the invention as described.

Various features of the invention are set forth in the following claims.

What is claimed is:

1. A blade clamp for use with a power tool having a reciprocating spindle, the blade clamp comprising:
a cover assembly rotatably coupled to the spindle;
a detent received within a first bore of the spindle, the detent movable in a radial direction relative to a longitudinal axis of the spindle by engagement with the cover assembly to adjust the blade clamp between a locked configuration and an unlocked configuration;
a sleeve in which the detent is slidably received, the sleeve at least partially positioned within the first bore; and
a plunger positioned within a second bore of the spindle, the second bore extending along a longitudinal axis that is parallel with the longitudinal axis of the spindle, the second bore being contiguous with a blade slot of the spindle.

2. The blade clamp of claim 1, wherein a combination of the second bore and the blade slot divides the spindle into a first portion and a second portion, and wherein the first bore extends through the first portion.

3. The blade clamp of claim 2, further comprising a pin coupled to the second portion of the spindle, wherein the pin includes an end positioned within the second bore but outside the blade slot.

4. The blade clamp of claim 3, further comprising a spring configured to bias the plunger toward the pin, wherein the plunger is engageable with the pin to prevent removal of the plunger from the second bore.

5. The blade clamp of claim 1, further comprising a spring coupling the cover assembly and the spindle, wherein the spring biases the cover assembly toward a first rotational position relative to the spindle coinciding with the locked configuration of the blade clamp, and wherein the cover assembly is rotatable against the bias of the spring toward a second rotational position relative to the spindle coinciding with the unlocked configuration of the blade clamp.

6. The blade clamp of claim 5, further comprising a pin coupled to the spindle and positioned within the second bore, wherein the plunger is engageable with an end of the detent and the pin when the blade clamp is in the unlocked configuration, and wherein the plunger maintains the cover assembly in the second rotational position when the blade clamp is in the unlocked configuration.

7. The blade clamp of claim 1, wherein the sleeve includes an aperture extending therethrough, and wherein the detent is received within the aperture such that a portion of the sleeve surrounds the detent within the first bore.

8. The blade clamp of claim 7, further comprising a body axially and rotationally fixed to the spindle, wherein the body includes an opening aligned with the first bore, wherein the sleeve includes a flange portion and a cylindrical portion, and wherein the flange portion is positioned within the opening and the cylindrical portion is positioned to surround the detent within the first bore.

9. The blade clamp of claim 7, wherein the sleeve includes a flange portion positioned between a head of the detent and the spindle, and wherein the flange portion is configured to prevent an end of the sleeve opposite the flange portion from extending into the blade slot.

10. A reciprocating saw comprising:
a housing;
a motor and a drive mechanism operably coupled to the motor, the motor and the drive mechanism positioned within the housing, the drive mechanism including a driven gear, a connecting rod, and a spindle, one end of the connecting rod movably coupled to the spindle by a roller pin, the spindle defining a longitudinal axis, wherein rotary motion of the motor is translated into linear reciprocating motion of the spindle by the driven gear and the connecting rod;
a support assembly configured to rotationally support the roller pin within the housing, the support assembly including
a housing defining a slot extending along a longitudinal axis that is aligned with the longitudinal axis of the spindle,
a first bearing positioned within the slot and at a first end of the roller pin, and
a second bearing positioned within the slot and at a second, opposite end of the roller pin;
wherein the roller pin extends transverse to the longitudinal axis of the slot, and
wherein at least one of the first end and the second end of the roller pin extends completely through the first bearing and the second bearing, respectively.

11. The reciprocating saw of claim 10, wherein the roller pin defines a connection between the connecting rod and the spindle, and wherein the housing of the support assembly is positioned to surround the connection between the connecting rod and the spindle.

12. The reciprocating saw of claim 10, wherein the connecting rod extends between a first end and a second end, wherein the first end is coupled to the driven gear by a crank pin, and wherein the one end of the connecting rod is the second end.

13. The reciprocating saw of claim 10, wherein the roller pin, the first bearing, and the second bearing are configured to move axially in a reciprocating motion along the slot.

14. The reciprocating saw of claim 10, wherein each of the first bearing and the second bearing has a thickness, and wherein the at least one of the first end and the second end of the roller pin extends completely through the thickness of the one of the first bearing and the second bearing, respectively.

15. The reciprocating saw of claim 14, wherein the first end and the second end of the roller pin extends completely through the thickness of the first bearing and the second bearing, respectively.

16. A reciprocating saw comprising:
a housing having a battery support portion configured to receive a battery pack; and
a motor and a drive mechanism operably coupled to the motor, the motor and the drive mechanism positioned within the housing, the motor configured to receive power from the battery pack,
wherein the battery support portion includes a plurality of rail members, each rail member engageable with a corresponding groove in the battery pack, and
wherein each rail member includes a metal support member.

17. The reciprocating saw of claim 16, wherein the battery support portion includes an interior surface and a plurality of channels defined between the interior surface and a surface of the respective rail members, and wherein a portion of each metal support member is positioned on the surface of the respective rail member.

18. The reciprocating saw of claim 16, wherein the metal support member includes a plurality of sections, wherein a first section of the plurality of sections is flat and positioned along a surface of the respective rail member.

19. The reciprocating saw of claim 18, wherein the battery support portion extends between a first end and a second end, wherein the first section of the metal support member is positioned between a second section and a third section of the metal support member, and wherein the second section is coupled to the first end of the battery support portion and the third section is coupled to the second end of the battery support portion.

20. The reciprocating saw of claim 18, wherein the first section of the metal support member is positioned between a second section and a third section of the metal support member, and wherein each of the second section and the third section is positioned at an angle relative to the first section.
